(19) United States
(12) Patent Application Publication
(10) Pub. No.: US 2006/0275573 A1
(43) Pub. Date: Dec. 7, 2006

(54) Pet hair remover

(75) Inventor: Wen Boley, Castle Rock, CO (US)

Correspondence Address: STARKWEATHER & ASSOCIATES;SUITE 200, 9035 SOUTH 1300 EAST, SANDY, UT, 84094, US

(73) Assignee: STICKYSHEETS UNLIMITED, LLC

(21) Appl. No.: 11/146,861

(22) Filed: Jun. 7, 2005

(51) Int. Cl. A47L 25/00; B32B 33/00

(52) U.S. Cl. 428/40.1; 15/104.002

(57) ABSTRACT

There is a cleaning device to clean hair, dirt, etc., having a flexible backing layer with holes configured to permit fluid transfer of air between the first and second surfaces, an adhesive disposed on the first surface of the flexible backing layer and configured to adhere thereto, and a release liner configured to removably couple to the adhesive, wherein the release liner includes first and second liner portions configured to completely cover first and second adhesive portions of the first surface of the backing layer, wherein each of the first and second liner portions are configured to be independently removable from the adhesive, and wherein the first liner portion includes a tab.

### BACKGROUND OF THE INVENTION

1. Field of the Invention

The present invention relates to cleaning devices, specifically to cleaning devices for removing dust and hair.

2. Description of the Related Art

Several devices are known for removing dust and pet hair from fabric. Typically a user will roll a cylindrical device over the fabric, wherein the cylindrical device may have an adhesive disposed on an outer surface. However, these devices are typically very small and are easily overcome with pet hair and dust as they are used, rendering them useless until adjusted.

Many objects needing to be cleaned are large. Therefore there may be a substantial amount of hair and dust to clean. There may also be a large surface area to cover. Using a typical roller-type device may be inefficient, wherein complete cleaning of an object may take a very long time. Further, using a larger device may be difficult, wherein the larger device may be unwieldy, as larger objects are generally more difficult to control. A larger device may be unwieldy due to a number of factors, including but not limited to increased maximum dimensions, increased weight, decreased ratio of structure strength to structure weight, increased resistance to air (acting as a sail), or any other factor or combination of factors that may make use of the device difficult. Where the large object includes a portion covered in adhesive, the difficulty in using is multiplied.

Further, there are safety concerns relating to cleaning large objects. Larger, more powerful devices typically present safety challenges, especially with regard to children and/or small animals. Using a larger or more powerful device including an adhesive may trap, suffocate, or otherwise harm those too weak, clumsy, or inexperienced to properly handle and/or clean using the device.

Accordingly, there exists a need for a cleaning device that may solve one or more of the problems described herein.

### SUMMARY OF THE INVENTION

The present invention has been developed in response to the present state of the art, and in particular, in response to the problems and needs in the art that have not yet been fully solved by currently available cleaning devices. Accordingly, the present invention has been developed to provide a cleaning device.

In one embodiment, there is a cleaning device for removing substantially loose materials from objects. The cleaning device may include a flexible backing layer, an adhesive, and a release liner. The flexible backing layer may have a first surface and a second surface. The adhesive may be disposed on the first surface of the flexible backing layer and configured to adhere thereto. The release liner may be configured to removably couple to the adhesive. The release liner may include first and second liner portions that may be configured to completely cover first and second adhesive portions of the first surface of the backing layer. The first and second liner portions may be configured to be independently removable from the adhesive.

It may be that the first adhesive portion extends along an edge of the cleaning device. Also, the first adhesive portion may extend over a corner of the cleaning device. The first liner portion may include a tab configured to facilitate removal of the first liner portion from the first adhesive portion. The first adhesive portion may be a generally elliptical area including from about 30% to about 90% of the entire area of the first surface.

The cleaning device may further include third, fourth, and/or fifth liner portions that may be configured to completely cover third, fourth, and/or fifth adhesive portions of the first surface of the backing layer. It may be that each of the third, fourth, and/or fifth liner portions are configured to be independently removable from the adhesive. Also, the first adhesive portion may be a generally elliptical area including from about 30% to about 90% of the entire area of the first surface, wherein each of the second, third, fourth, and fifth adhesive portions may extend over a corner of the cleaning device;

In one embodiment, the first adhesive portion may be a generally rectangular in area and may extend to at least a first edge and a second edge of the cleaning device. The first adhesive portion may be a torus. The first adhesive portion may define a two dimensional torus. The first adhesive portion may extend along each edge of the first surface. The flexible backing layer may further include a plurality of air permeable portions configured to permit fluid transfer of air between the first and second surfaces. The first surface may be generally planar. The first surface may have an area from about 470 square centimeters to about 1.4 square meters.

In one embodiment, there may be a cleaning device for removing substantially loose materials from objects. The cleaning device may include a flexible backing layer, an adhesive, and a release liner. The flexible backing layer may include a first surface, a second surface, and/or a plurality of air permeable portions that maybe configured to permit fluid transfer of air between the first and second surfaces. The adhesive may be disposed on the first surface of the flexible backing layer and/or may be configured to adhere thereto, without significant obstruction of the plurality of permeable portions. The release liner may be configured to removably couple to the adhesive.

The plurality of air permeable portions may be arranged in offset rows. The flexible backing layer may be a loosely woven material. The plurality of air permeable portions may be generally circular holes. The release liner may include first and/or second liner portions that may be configured to completely cover first and second adhesive portions of the first surface of the backing layer. It may be that each of the first and second liner portions are configured to be independently removable from the adhesive. Also, the plurality of air permeable portions may be generally evenly distributed about the flexible backing layer, may have a density from about one air permeable portion per square 0.25 centimeter to about one air permeable portion per square 9 centimeters, and/or may include at least about 30% of the area of the flexible backing layer.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of a cleaning device in operation on a couch according to one embodiment of the invention;

FIG. 2 illustrates a back partial plan view of a cleaning device according to one embodiment of the invention;

FIG. 3 illustrates a back partial plan view of a cleaning device according to one embodiment of the invention;

FIG. 4 illustrates a back plan view of a cleaning device according to one embodiment of the invention;

FIG. 5 illustrates a back plan view of a cleaning device according to one embodiment of the invention; and

FIG. 6 illustrates a back plan view of a cleaning device according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

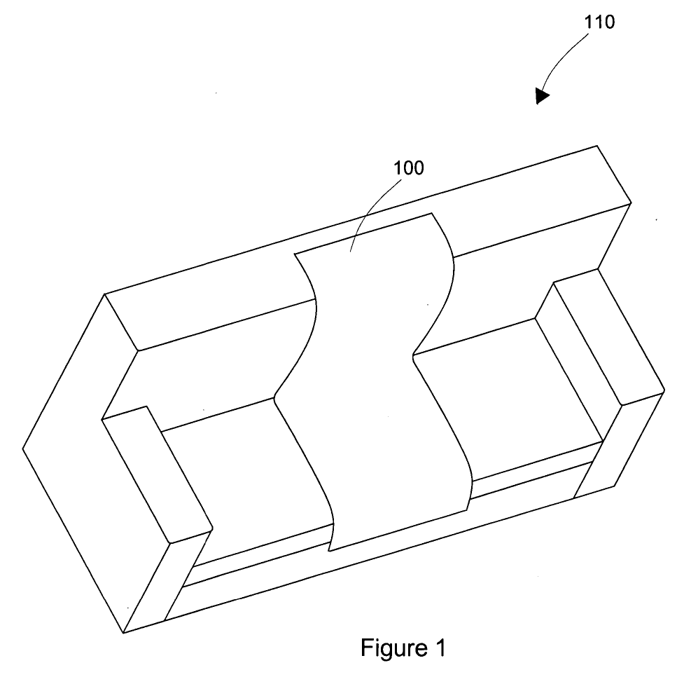

FIG. 1 illustrates a perspective view of a cleaning device 100 in operation on a couch 110 according to one embodiment of the invention. The cleaning device 100 may be substantially planar and may be flexible. The cleaning device 100 may be rectangular or may be any other shape, such as, but not limited to circular, polygonal, irregular, etc. The cleaning device 100 may be flexible. The cleaning device 100 may be a single sheet of material, such as, but not limited to, plastic, paper, fiber, resin, metal, ceramic, composite, etc. The cleaning device 100 may be configured with at least one surface of a sheet of material, for example a first surface, having an adhesive disposed thereon. There may be a second surface that may be used as a contact location from which to apply pressure to the cleaning device to press the cleaning device against an object to be cleaned. The adhesive is preferably a pressure sensitive adhesive. The flexible sheet is a backing layer configured to hold the adhesive and to hold (by means of the adhesive) dirt, dust, hair, lint, and other generally loose objects and materials to be cleaned from an object by the device. Preferably, the backing layer strongly adheres to by the adhesive, thereby preventing transfer of the adhesive from the backing layer to the object to be cleaned.

The cleaning device 100 may be large compared to conventional devices. For example, the cleaning device 100 may be a sheet of material that may be larger than about 930 square centimeters. In another example, the cleaning device 100 may be a rectangle having a first side length of about 0.7 meters and a second side length of about 1.5 meters. The cleaning device 100 may be of any dimensions. The cleaning device 100 may be large enough to require handling with two hands, or more than one person.

In operation, the cleaning device 100 may be disposed on an object to be cleaned, such as a surface of a couch 110. The cleaning device 100 may rest on the surface with an adhesive surface disposed towards the surface of the object to be cleaned. The adhesive surface may adhere to hair, particles of dust, etc.

The device may be large, especially as compared to typical cleaning devices, and/or especially having a total surface area of a significant percentage of a total surface area of an object to be cleaned (for example, greater than about 10%, or than about 25%, or than about 33% of the total surface area of an object to be cleaned). The device may include a surface or a first surface intended to be a cleaning surface having an adhesive layer thereon. The first surface may have an area of from about 90 square centimeters, or about 230 square centimeters or about 470 square centimeters, or about 930 square centimeters to about 1400 square centimeters, or about 0.5 square meters, or about 1.4 square meters, or about 3.25 square meters. A first surface may be larger or smaller than the ranges of sizes described herein. A large cleaning device may advantageously permit rapid cleaning of an object. Also, being large, the cleaning device may perform a cleaning without becoming saturated with dust, hair, etc.

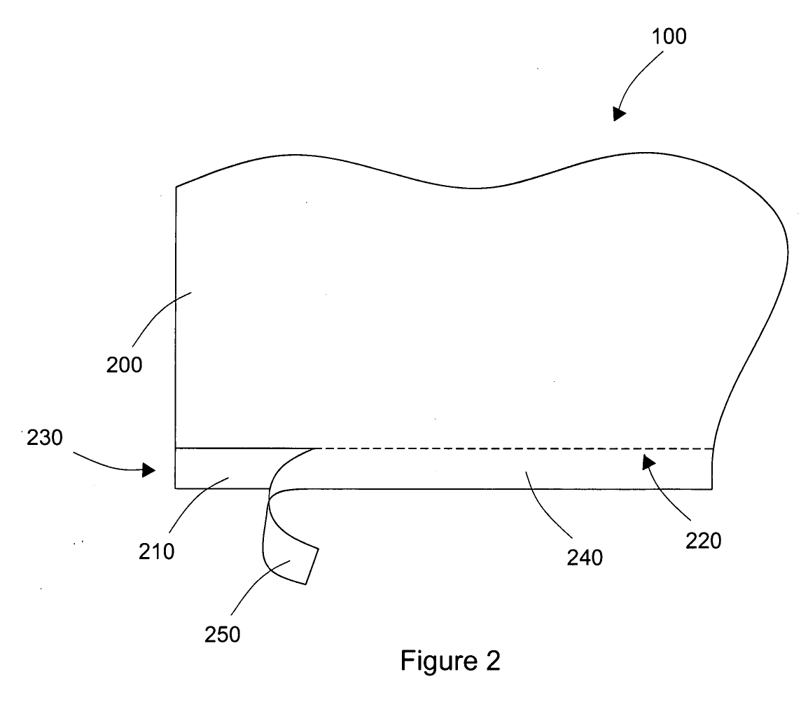

FIG. 2 illustrates a back partial plan view of a cleaning device 100 according to one embodiment of the invention. There may be a release liner 200 disposed over an adhesive layer 210 that may be disposed on a backing layer, being a surface of a cleaning device 100. The release liner 200 may be of a material that may be removably attachable to an adhesive, such as but not limited to release liner materials commonly known in the art. The release liner 200 may be any release liner or transfer liner known to those skilled in the art. The liner 126 should also be capable of being placed in intimate contact with a pressure sensitive adhesive and subsequently removed without sufficiently damaging the adhesive layer. Non-limiting examples of liners include materials from Minnesota Mining & Manufacturing Company (3M) of St. Paul, Minn., Rexam Corporation of Iowa City, Iowa, or Daubert Coated Products of Westchester, Ill. The liner 126 is typically a polymer coated paper with a silicone release coating, a polyethylene coated polyethylene terepthalate (PET) film with silicone release coatings, or a cast polypropylene film with a silicone release coating.

The release liner 200 may include one or more perforations 220. Perforations 220 may include scored material, dashed portions of cut and/or scored material, cut material, or any other structure configured to provide separation between two sections of material. A perforation 220 may even include where the two sections are diverse materials that may only be adjacent. There may be a perforation 220 extending along a portion of a release liner 200. The perforation 220 may extend along a side of the cleaning device 100 and may be disposed a distance from an edge 230 of the side of the cleaning device 100. The perforation 220 may be a substantially consistent distance from an edge 230 of the cleaning device 100, thereby forming a strip 240 of substantially constant width that may extend along the edge 230 of the cleaning device. The strip 240 may be removed from the cleaning device 100 as shown by portion 250. The strip 240 may extend beyond the backing layer in one or more dimension. For example, the strip of release liner 240 may be wider than the backing layer and the additional width of material may form a tab configure to permit easy removal of the strip of release liner 240.

In operation, a user may remove a portion of the release liner 200 corresponding to one of the portions formed by the perforation 220. A user may remove a strip 240 of release liner material, thereby exposing the adhesive layer 210. The user may attach the exposed adhesive layer 210 to an object to be cleaned while handling the cleaning device 100 at a portion still covered by a release liner 200. The portion still covered by the release liner 200 may be larger, smaller, or substantially identical in size to the portion of exposed adhesive layer 210.

A user may keep a portion covered by release liner material 200 to enable repeated application of the cleaning device 100 to various sections of an object or to multiple objects without ever having to touch an adhesive layer. For example, and not by way of limitation, a user may remove a large section of release liner material, leaving a strip of release liner material near and edge attached. Then the user may grip the cleaning device 100 at the strip of remaining release liner material and use the strip portion as a tab to repeatedly apply and remove the cleaning device from one or more objects to be cleaned.

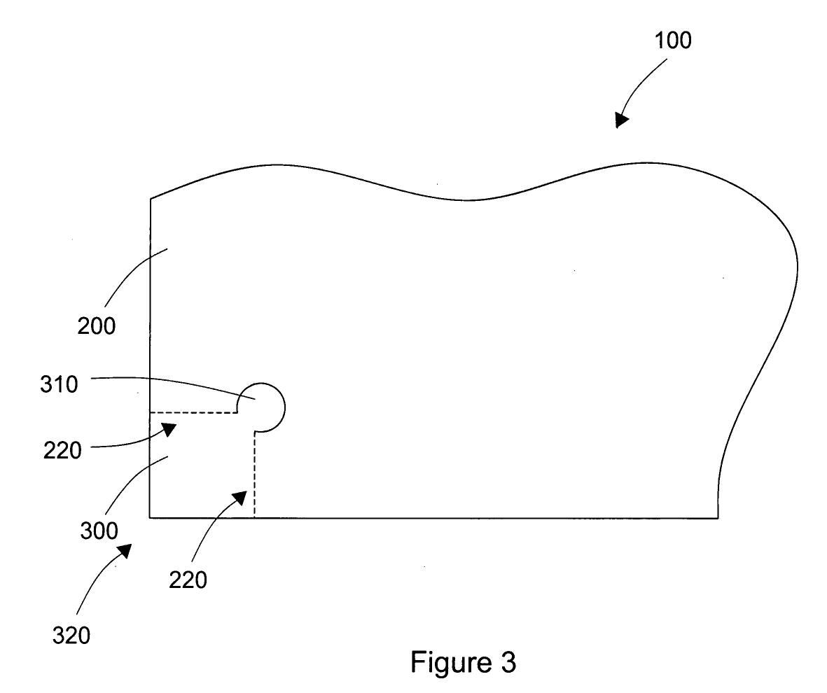

FIG. 3 illustrates a back partial plan view of a cleaning device 100 according to one embodiment of the invention. There may be a release liner 200 that may be portioned by one or more perforations 220. There may be a corner portion 300 disposed at, adjacent to, or near a corner 320 of a cleaning device 100. The corner portion 300 may be separately removable from the cleaning device 100. The corner portion 300 may include a tab 310 configured to facilitate easy removal of the corner portion 300 from the cleaning device 100, thereby exposing a section of adhesive 210 (see FIG. 2) in substantially the same shape as the removed corner portion 300.

In operation, a user may grip a tab 310, advantageously more easily gripped than an un-tabbed piece of release liner material. The user may pull the tab, thereby peeling the corner portion 300 from the corner 320 of the cleaning device 100 and exposing a section of adhesive 210. A user may then attach the corner 320 of the cleaning device 100 by pressing the exposed adhesive 210 to the object to be cleaned. Then a user may position the cleaning device 100 as desired before removing additional release liner 200 and applying the cleaning device 100 to the object to be cleaned.

In one embodiment, a layer of release liner may initially substantially or completely cover the corner portion 300. The layer of release liner may or may not be tabbed. The corner portion may or may not be tabbed. In operation, a user may remove the release liner, excepting removal of the corner portion 300. The user may then apply the cleaning device 100 to an object, using the corner portion 300 as a location from which to grip the cleaning device 100 without touching the adhesive. When the cleaning device 100 is positioned as desired, the corner portion 300 may be removed.

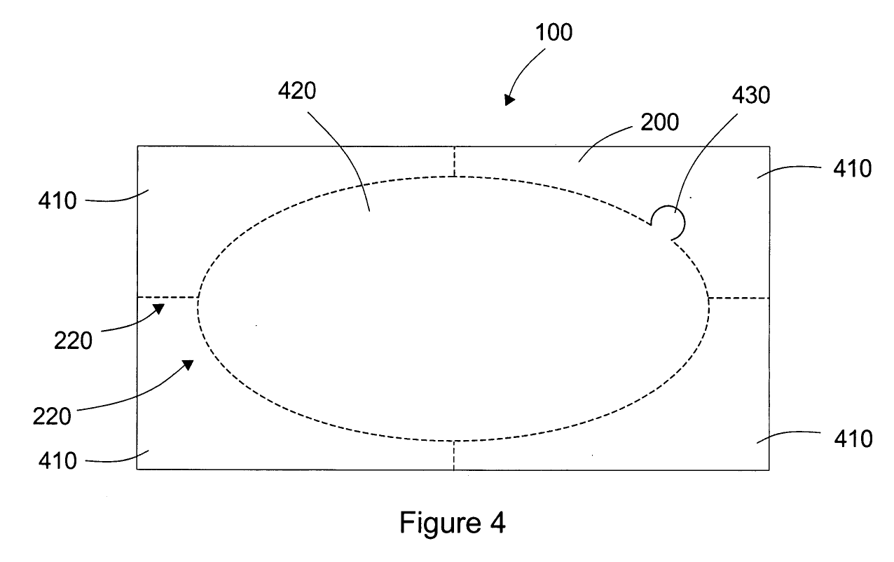

FIG. 4 illustrates a back plan view of a cleaning device 100 according to one embodiment of the invention. There may be a cleaning device 100 that may include a release liner 200 that may include one or more sections 410 and 420. The sections 410 and/or 420 may be formed by one or more perforations 220 that may be in or through the release liner 200. There may be a central section 420 that may be configured to be independently removable from the cleaning device 100. The central section may cover from about 10% or about 25% or about 30% or about 40% to about 50% or about 60% or about 75% or about 90% of the area of the adhesive. The central section 420 may include a tab 430. The tab 430 may be configured to facilitate removal of the central section 420. There may be a corner section 410 that may be configured to be independently removable from the cleaning device 100. The corner section may include a tab (not shown) that may be configured to facilitate removal of the corner section 410.

In operation, a user may remove one or more sections 410 and/or 420 of release liner 200 from the cleaning device 100, thereby exposing an adhesive layer section. The user may remove one or more sections 410 and/or 420 by pulling one or more tabs 430. The user may remove a central section 420, thereby exposing a central area of adhesive 210. The user may then cause a central area of the cleaning device to adhere to an object to be cleaned, corresponding with the area of the removed central section 420 of release liner material 200. The user may handle the cleaning device 100 by gripping portions of remaining release liner 200 and may remove sections 420 and/or 410 of release liner 200 as desired. Sectional removal of release liner 200 may advantageously facilitate proper handling, placement, and/or use of the cleaning device.

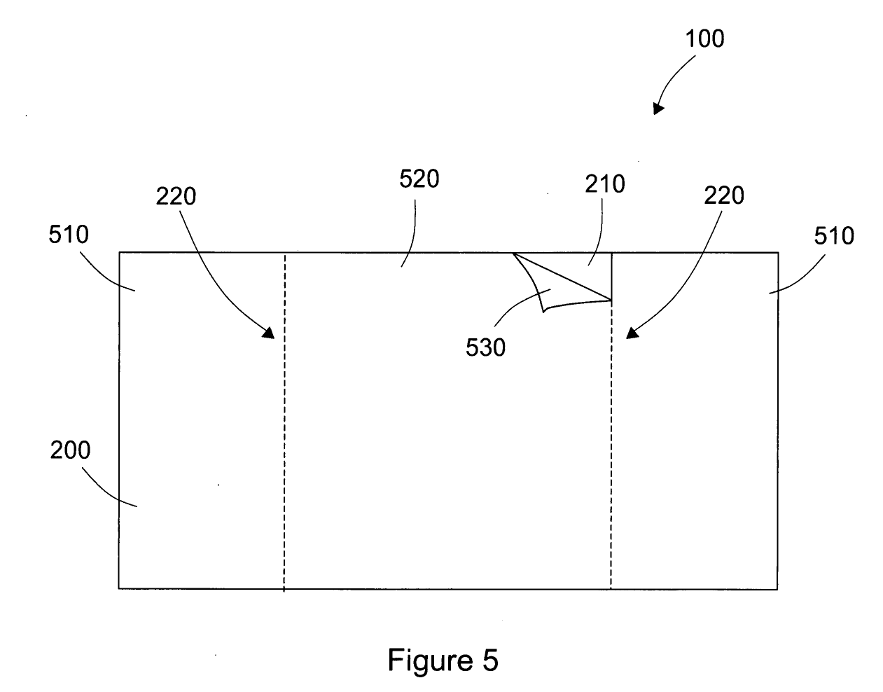

FIG. 5 illustrates a back plan view of a cleaning device according to one embodiment of the invention. There may be a cleaning device 100 that may include a release liner 200 over an adhesive layer 210. The release liner 200 may include one or more sections 510 and 520. There may be one or more side release liner portions 510. There may be one or more central release liner portions 520. There may be one or more perforations 220 defining the portions of release liner 520 and/or 510. The perforations 220 may be configured to enable separate removal of each of the portions of release liner 510 and/or 520. The perforations 220 may extend substantially linearly across the release liner 200, thereby forming rectangular sections 510 and/or 520.

In operation, a user may remove one or more portions of release liner 510 and/or 520. A user may pull away a small section 530 of a portion of release liner 220, thereby exposing an adhesive layer 210. The cleaning device may then be used as previously described.

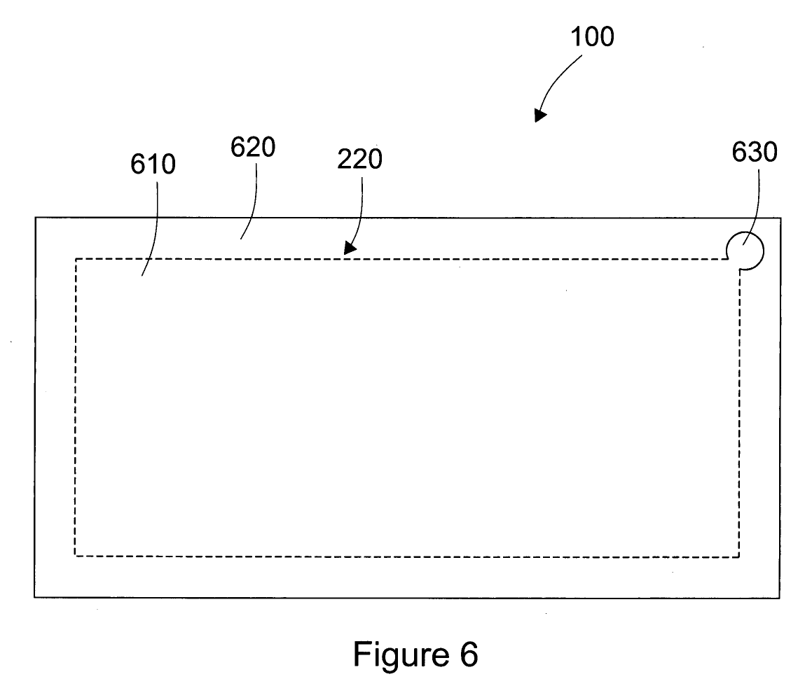

FIG. 6 illustrates a back plan view of a cleaning device 100 according to one embodiment of the invention. There may be a cleaning device 100 that may include a release liner over an adhesive layer 210 (see FIG. 5). There may be one or more sections 610 and/or 620 in the release liner that may be defined by one or more perforations 220. There may be a central section 610 of release liner material that may include a tab 630. The tab 630 may be configured to facilitate removal of the central section 610 of release liner material. There may be an edge section 620 of release liner material. The edge section 620 may be defined by a perforation 220 that may extend near an outer perimeter of a cleaning device 100 and may extend a substantially consistent distance from the outer perimeter of the cleaning device, thereby forming a strip of release liner material that may form a rectangular loop. There may be a plurality or multiplicity of air permeable portions 640 such as but not limited to holes, perforations, slits, slots, or other means whereby air may pass through the device 100.

The plurality of holes 640 may extend through one or more layers of the device. For example, one or more of the plurality of holes 640 may be present or absent from the release liner 200. Preferably, each of the plurality of holes 640 extends through the backing layer. Also, preferably, the adhesive does not significantly obstruct fluid transfer of air through the plurality of holes 640 at least when the release liner is removed. An adhesive significantly prevents air transfer through the plurality of holes 640 when a primary function of the plurality of holes is obstructed. For example, but not by way of limitation, where a primary function of the plurality of holes is to prevent suffocation of a child, an adhesive does not significantly prevent air transfer through the plurality of holes when air may only transfer through the holes when under at least pressure similar to that of a breathing child. In the same example, where an adhesive significantly prevents air transfer through the plurality of hole while under conditions similar to that of a breathing child, the adhesive significantly prevents air transfer through the plurality of holes 640.

Advantageously, the plurality of holes enables air to pass through the device 100, reducing the likelihood of trapping and/or suffocating children and/or small animals. Further, the plurality of holes may advantageously reduce or increase an overall bonding strength (that may be significantly and detrimentally enhanced by the enhanced dimensions of the enlarged device) by reducing a total surface area of adhesive without reducing maximum dimensions of the device 100 and/or by reducing a number and/or size of air bubbles formed when the device 100 may be applied to the surface of an object to be cleaned. Still further, the weight of the device 100 may be advantageously reduced in particular wherein the plurality of holes may represent material removed from the device 100.

The plurality of holes 640 may be of any shape, including but not limited to circles, squares, rectangles, triangles, polygons, irregular shapes, and/or any combination thereof. The plurality of holes 640 may be each generally the same size or may be of diverse sizes. The plurality of holes 640 may be from about 0.5 mm or about 0.75 mm or about 1 mm to about 1 mm or about 2 mm or about 4 mm in diameter. The plurality of holes 640 may each be smaller or larger than the previously mentioned ranges. The plurality of holes 640 may be present over any portion of the device 100, including an entirety of the device 100.

The plurality of holes 640 may be arranged according to a pattern or may be randomly dispersed about the device. The plurality of holes 640 may be arranged as a safety feature, wherein the holes may be configured to permit breathing when a device may affix to the face of a person, in particular a child. In one embodiment, the device 100 may be constructed of a loosely woven webbing material that may permit air to pass through between individual strands.

In one embodiment, the holes or spaces 640 may be sufficiently densely positioned on the device 100 that at least one hole or space may be present for any position a mouth may take when affixed to the device, for example when affixed by the adhesive of the device. Preferably, the holes are circular and patterned in offset columns as depicted in FIG. 6. In one embodiment, the plurality of holes have a density from about one air permeable portion per square 0.1 centimeter, or per square 0.25 centimeter, or per square 0.5 centimeter, or per square centimeter to about one air permeable portion per square 4 centimeters, per square 9 centimeters, per square 12 centimeters, per square 15 centimeters.

### EXAMPLE

The following examples are provided for an illustration of the envention only and are not meant to be limiting to the invention in any way. The claims will serve the purpose of limiting the invention.

In one example, a cleaning device was prepared using a clear plastic film having a thickness of about 1.5 mm, a length of about 122 cm, and a width of about 61 cm. There were holes in the plastic film. The holes had diameter of about 3 mm and were in offset rows such that there was about a 2.5 cm distance between neighboring holes. There was a border portion extending in about 7 cm about the edges of the plastic film wherein there were no holes. There was a pressure sensitive adhesive on one surface of the plastic film.

In another example, a cleaning device was prepared using a first release liner having a length of about 5 cm and a width of about 63 cm. There was also a second release liner having a length of about 117 cm and a width of about 63 cm. Both the first and second release liners had a non-stick coating on one surface and had printing on the other surface.

The first release liner and the second release liner were positioned on the clear plastic film over the adhesive and such that the entire surface of the clear plastic film having the adhesive was covered with both release liners extending beyond the width of the clear plastic film by 1 cm on each of two opposite sides.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures illustrate specific shapes of sections of separately removable release liner, it is envisioned that a great variety of shapes may be incorporated in the invention including but not limited to squares, triangles, rectangles, polygons, irregular shapes, strips, circles, loops, and shapes similar to such shapes.

Additionally, although the figures illustrate rectangular cleaning devices, it is envisioned that the invention may be embodied in any shape of cleaning device, including but not limited to squares, triangles, rectangles, polygons, irregular shapes, strips, circles, loops, shapes similar to such shapes, and any combinations thereof including three dimensional varieties such as spheres, polyhedrons, irregular shapes, etc.

It is also envisioned that different sections of release liner material may be made of diverse materials. For example, a strip may be made of a shiny foil material, while the balance of the release liner material may be plastic or wax paper.

Finally, it is envisioned that the components of the device may be constructed of a variety of materials, including but not limited to resins, polymers, ceramics, metals, composites, fibers, wood, plastics, adhesives, glues, tacky materials, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A cleaning device for removing substantially loose materials from objects, comprising:
a flexible backing layer having a first surface and a second surface;
an adhesive disposed on the first surface of the flexible backing layer and configured to adhere thereto; and
a release liner configured to removably couple to the adhesive, wherein the release liner includes first and second liner portions configured to completely cover first and second adhesive portions of the first surface of the backing layer, wherein each of the first and second liner portions are configured to be independently removable from the adhesive.

2. The cleaning device of claim 1, wherein the first liner portion comprises a generally rectangular strip positioned about a peripheral edge of the cleaning device.

3. The cleaning device of claim 1, wherein the first liner portion comprises being positioned over a corner of the cleaning device.

4. The cleaning device of claim 1, wherein the first liner portion includes a tab configured to facilitate removal of the first liner portion from the first adhesive portion.

5. The cleaning device of claim 1, wherein the first adhesive portion comprises being a generally elliptical area including from about 30% to about 90% of the entire area of the first surface.

6. The cleaning device of claim 1, further comprising third, fourth, and fifth liner portions configured to completely cover third, fourth, and fifth adhesive portions of the first surface of the backing layer, wherein each of the third, fourth, and fifth liner portions are configured to be independently removable from the adhesive.

7. The cleaning device of claim 6, wherein the first adhesive portion comprises being a generally elliptical area including from about 30% to about 90% of the entire area of the first surface, and wherein each of the second, third, fourth, and fifth adhesive portions extend over a corner of the cleaning device.

8. The cleaning device of claim 1, wherein the first adhesive portion comprises being a generally rectangular in area and extends to at least a first edge and a second edge of the cleaning device.

9. The cleaning device of claim 1, wherein the first adhesive portion comprises a two-dimensional toroid.

10. The cleaning device of claim 9, wherein the first adhesive portion comprises a two dimensional toroid positioned along each peripheral edge of the device.

11. The cleaning device of claim 1, wherein the flexible backing layer further includes a plurality of air permeable portions configured to permit fluid transfer of air between the first and second surfaces.

12. The cleaning device of claim 1, wherein the first surface is generally planar.

13. The cleaning device of claim 1, wherein the first surface includes an area from about 470 square centimeters to about 1.4 square meters.

14. A cleaning device for removing substantially loose materials from objects, comprising:
a flexible backing layer having:
a first surface;
a second surface; and
a plurality of air permeable portions configured to permit fluid transfer of air between the first and second surfaces;
an adhesive disposed on the first surface of the flexible backing layer and configured to adhere thereto, without significant obstruction of the plurality of permeable portions; and
a release liner configured to removably couple to the adhesive.

15. The cleaning device of claim 14, wherein the plurality of air permeable portions are arranged in offset rows.

16. The cleaning device of claim 14, wherein the flexible backing layer includes a loosely woven material.

17. The cleaning device of claim 14, wherein the plurality of air permeable portions comprise generally circular holes.

18. The cleaning device of claim 15, wherein the release liner includes first and second liner portions configured to completely cover first and second adhesive portions of the first surface of the backing layer, wherein each of the first and second liner portions are configured to be independently removable from the adhesive.

19. The cleaning device of claim 14, wherein the plurality of air permeable portions comprise generally evenly distributed air permeable portions about the flexible backing layer, a density from about one air permeable portion per square 0.25 centimeter to about one air permeable portion per square 9 centimeters, and include at least about 30% of the area of the flexible backing layer.

20. A cleaning device for removing substantially loose materials from objects, comprising:
a flexible backing layer having:
a first surface;
a second surface; and
a plurality of air permeable portions configured to permit fluid transfer of air between the first and second surfaces, wherein the plurality of air permeable portions are arranged about the flexible backing layer in generally offset rows, and wherein the plurality of air permeable portions are generally evenly distributed about the flexible backing layer, have a density from about one air permeable portion per square 0.25 centimeter to about one air permeable portion per square 9 centimeters, and include at least about 30% of the area of the flexible backing layer;
an adhesive disposed on the first surface of the flexible backing layer and configured to adhere thereto; and
a release liner configured to removably couple to the adhesive, wherein the release liner includes first and second liner portions configured to completely cover first and second adhesive portions of the first surface of the backing layer, wherein each of the first and second liner portions are configured to be independently removable from the adhesive, and wherein the first liner portion includes a tab.
